(19) United States
(12) Patent Application Publication
(10) Pub. No.: US 2007/0153630 A1
(43) Pub. Date: Jul. 5, 2007

(54) Seismic sensitive cable and a seismic sensitive ribbon for detecting intruders over long lines

(76) Inventors: Alexander Pakhomov, Yonkers, NY (US); Tim Goldburt, Chappaqua, NY (US)

Correspondence Address: Ilya Zborovsky, 6 Schoolhouse Way, Dix Hills, NY, 11746, US

(21) Appl. No.: 11/322,194

(22) Filed: Dec. 29, 2005

(51) Int. Cl. G01V 1/20

(52) U.S. Cl. 367/177

(57) ABSTRACT

A seismic sensitive cable and a seismic sensitive ribbon for detecting introducers over long lines has a plurality of miniature geophones each having three conductors extending therefrom, three lines connecting the conductors of the geophones in parallel with one another, an elastic sheath covering the lines and extending in a predetermined direction, a plurality of substantially hard cases each covering a respective one of the miniature geophones, wherein the elastic sheath connects the hard cases with one another.

### BACKGROUND OF THE INVENTION

The present invention relates to a seismic sensitive cable and a seismic sensitive ribbon for detecting intruders over long lines.

Systems for detecting intruders over long lines are known. One of such systems is disclosed for example in U.S. Pat. No. 6,664,894. It utilizes geophones or sensors, as disclosed for example in U.S. patent application Ser. No. 10/659,355.

In the above mentioned known system it is believed to be advisable to further improve the connections of the miniature geophones and to provide a system which allows easy manufacture, transportation and installation.

### SUMMARY OF THE INVENTION

Accordingly, it is an object of the present invention to provide a seismic sensitive cable and a seismic sensitive ribbon for detecting intruders over long lines which is a further improvement of the existing systems.

In keeping with these objects and with others which will become apparent hereinafter, one feature of the present invention resides, briefly stated, in a seismic sensitive cable for detecting introducers over long lines, comprising a plurality of miniature geophones each having three conductors extending therefrom; three lines connecting said conductors of said geophones in parallel with one another; an elastic sheath covering said lines and extending in a predetermined direction; and a plurality of substantially hard cases each covering a respective one of said miniature geophones, said elastic sheath connects said hard cases with one another.

In accordance with another feature of the present invention, a seismic sensitive ribbon is formed, which incorporates the seismic cable and additional elements.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a connection of a plurality of miniature geophones with one another by corresponding wires;

FIG. 2 is a view showing a seismic sensitive cable in accordance with the present invention; and

FIG. 3 is a view showing a seismic sensitive ribbon in accordance with the present invention.

### DESCRIPTION OF THE PREFERRED EMBODIMENTS

A system for detecting intruders over long lines in accordance with the present invention includes a plurality of miniature geophones which are identified as a whole with reference numeral 1. Such miniature geophones are disclosed for example in our U.S. patent application Ser. No. 10/659,355 which incorporated here by reference.

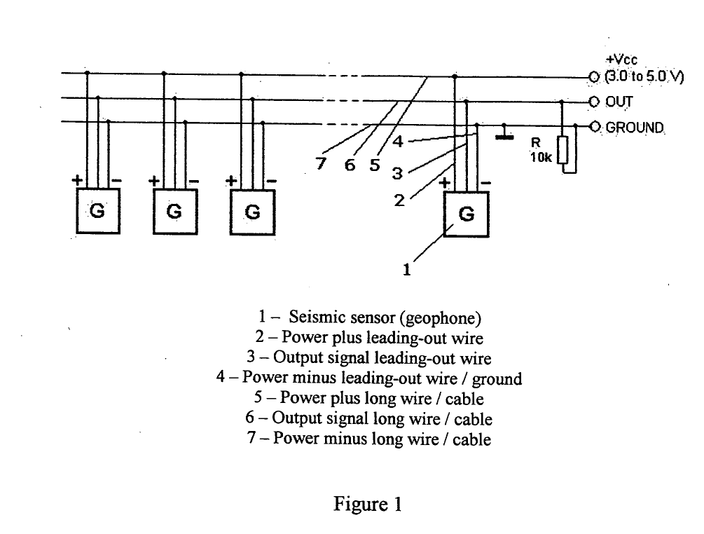

Each geophone has three conductors shown in FIG. 1 and identified as 2, 3 and 4. The conductors are connected with one another by three wires in parallel with one another. The wires which include a positive power supply wire 5 which can supply for 3.0-5.0 V, an output wire 6, and a negative power supply wire.

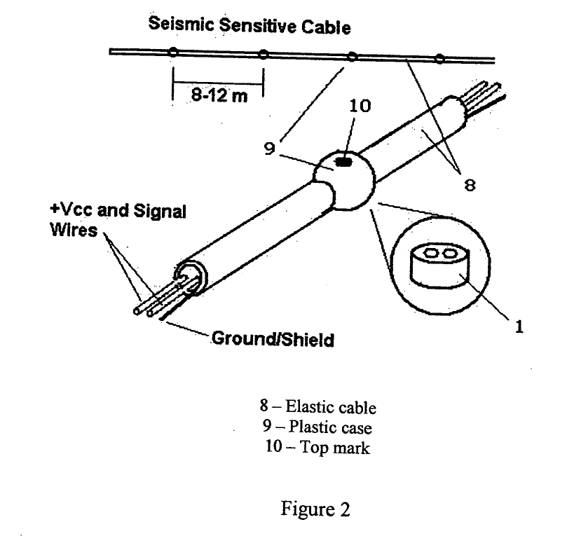

As shown in FIG. 2, the wires 5, 6, 7 are accommodated in an elastic sheath 8 extending in a longitudinal direction. On the other hand, the geophones 1 are accommodated in a hard case 9. The cases 9 are connected with one another via the elastic sheaths 8. The elastic sheaths can be composed of an elastic plastic, while the hard case 9 can be composed of a hard plastic, and they can be connected with one another for example by glueing, melting, etc. A top mark 10 is provided on the hard case 9 to facilitate the orientation of the cases 9.

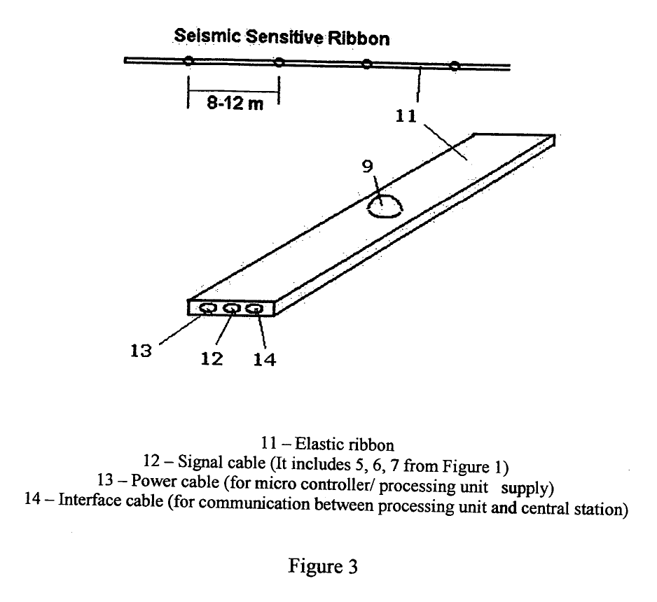

FIG. 3 shows a seismic sensitive ribbon for a system of detecting intruders over long lines, in accordance with the present invention.

The seismic sensitive ribbon has a ribbon-shaped additional casing identified with reference numeral 11 and extending in a direction of elongation. Reference numeral 12 identifies the seismic sensitive cable which is shown in FIG. 2 and embedded in addition casing 11.

Reference numeral 13 identifies a power supply cable which is also embedded in the additional casing 11 and provided for supplying power to processing units which are disclosed for example in U.S. Pat. No. 6,664,894. Finally, reference numeral 14 identifies an interface cable which connects all processing units to the central command unit, as also disclosed in the above mentioned U.S. Pat. No. 6,664,894 which incorporated here by reference.

The additional casing 11 can be composed of an elastic plastic, and the hard cases 9 are also embedded in the elastic plastic.

The seismic sensitive ribbon can be wound in rolls and easily transported to the points of installation.

It will be understood that each of the elements described above, or two or more together, may also find a useful application in other types of constructions differing from the types described above.

While the invention has been illustrated and described as embodied in seismic sensitive cable and a seismic sensitive ribbon for detecting intruders over long lines, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A seismic sensitive cable for detecting introducers over long lines, comprising a plurality of miniature geophones each having three conductors extending therefrom; three lines connecting said conductors of said geophones in parallel with one another; an elastic sheath covering said lines and extending in a predetermined direction; a plurality of substantially hard cases each covering a respective one of said miniature geophones, said elastic sheath connecting said hard cases with one another.

2. A seismic sensitive cable as defined in claim 1, wherein each of said hard cases is substantially spherical.

3. A seismic sensitive cable as defined in claim 1, wherein each of said hard cases has a top mark identifying a top of a respective one of said miniature geophones for placement of said miniature geophones in a proper orientation.

4. A seismic sensitive cable as defined in claim 1; and further comprising an additional casing which covers said cable and is formed as a ribbon.

5. A seismic sensitive cable as defined in claim 4; and further comprising a power cable which is also accommodated in said additional casing.

6. A seismic sensitive cable as defined in claim 5, wherein said power cable provided is configured for supplying power to processing units.

7. A seismic sensitive cable as defined in claim 6; and further comprising an interface cable accommodated in said additional casing for connecting the processing units with a central command unit.

8. A seismic sensitive cable as defined in claim 1, wherein said elastic sheath is composed of an elastic plastic.

9. A seismic sensitive cable as defined in claim 1, wherein said hard case is composed of a hard plastic.

10. A seismic sensitive cable as defined in claim 4, wherein said additional casing is composed of elastic plastic to form a ribbon structure.
